(19) United States
(12) Patent Application Publication
(10) Pub. No.: US 2022/0144611 A1
(43) Pub. Date: May 12, 2022

(54) ELECTRIC LIFTING TYPE CARGO WORK PLATFORM

(71) Applicant: ZHEJIANG DINGLI MACHINERY CO., LTD., Huzhou (CN)

(72) Inventors: Shugen Xu, Huzhou (CN); Zhong Xu, Huzhou (CN)

(21) Appl. No.: 17/146,754

(22) Filed: Jan. 12, 2021

(30) Foreign Application Priority Data
Nov. 6, 2020 (CN) 2020112284546

(51) Int. Cl. B66F 11/04; B66F 17/00

(52) U.S. Cl. CPC B66F 11/04; B66F 17/006

(57) ABSTRACT

The present disclosure provides an electric lifting type cargo work platform. It includes a frame, a column, a stand and a shelf. The column is provided on the frame, and includes an electric push rod and a multi-stage sleeve. The multi-stage sleeve includes an outer sleeve, an inner sleeve, and a middle sleeve. The middle sleeve is provided with rollers, and each of the roller is provided with a chain. One end of the chain extends downward and is connected to the outer sleeve, the other end is connected to the frame. The output end of the electric push rod is connected to the middle sleeve. The stand and the shelf are provided on the column and can move in a height direction by means of the column.

### TECHNICAL FIELD

The present disclosure relates to the technical field of aerial work platforms, and in particular, to an electric lifting type cargo work platform.

### BACKGROUND

Aerial work platform has been a product that serves mobile aerial works such as aerial works, equipment installation and maintenance in various industries. The related products of aerial work platform mainly include the following six categories: scissor aerial work platform, vehicle-mounted aerial work platform, crank arm aerial work platform, self-propelled aerial work platform, aluminum alloy aerial work platform, and cylinder-type aerial work platform. Most of them use engines or hydraulic methods to provide power for the lifting mechanisms to lift the working platforms, which generally suffer from problems such as loud noise, serious exhaust gas pollution, easy oil leakage, and inconvenient maintenance. For lifting type cargo picking trucks, in addition to most using indoors, especially in the warehouse, it is necessary to reduce the impact on the environment, but also need to conside the changes in the center of gravity of the platform caused by changes in the operator and the goods, that is, higher requirements are needed in the stability and safety of the platform.

### SUMMARY

The present disclosure provides an electric lifting type cargo work platform, which has the advantages of safety, friendliness to environment and low noise. It is more suitable for indoor goods picking operations, and can meet the needs of society for energy conservation and emission reduction. The structure is compact with high safety.

In order to achieve the purpose, the present disclosure adopts the following technical solutions:

An electric lifting type cargo work platform, wherein, comprises: a frame, a column, a stand and a shelf; the column may be provided on the frame, the column may include an electric push rod and a multi-stage sleeve. The multi-stage sleeve may include a connecting cylinder, an outer sleeve, an inner sleeve, and a middle sleeve. The middle sleeve may be provided with rollers, each of the rollers may be provided with a chain, and one end of the chain may extend downward and may be connected to the outer sleeve, the other end may be connected with the frame. The output end of the electric push rod may be connected with the middle sleeve, the stand and the shelf may be provided on the column and is capable to move in a height direction by means of the column. The synchronous lifting of the sleeves may be realized through the electric push rod and the chain drive structure, which has the advantages of safety, friendliness to environment, and convenient maintenance and repair.

As a preference, the electric push rod may include a motor, a brake, a reducer, a screw and a push rod. The reducer and the brake may be provided on both sides of the motor, and the output end of the reducer may be connected to the screw and may drive the screw to rotate, and the screw may drive the push rod to move. The use of an integrated brake structure reduces the size of the motor and may be easy to arrange in the frame.

As a preference, the front and rear ends of the middle sleeve may be provided with the rollers, the chain may bypass the two rollers. One end may be located on one side of the shelf and may extend downward to the lower end of the outer sleeve, and the other end may be located on one side of the stand and extend downward to connect with the bottom plate of the frame.

As a preference, the outer sleeve may be provided with a connecting cylinder, the stand and the shelf may be provided on the connecting cylinder. The outer sleeve may be provided with a detection chain, and the connecting cylinder may be provided with a fixing seat. One end of the detection chain may be provided with a connecting rod, the connecting rod passes through the fixing seat and a spring may be provided between the fixing seat and the connecting rod. The connecting rod may be provided with an anti-loosening rod, the side of the anti-loosening rod may be provided with a micro switch.

As a preference, the frame may be provided with two driving wheels, and the driving wheels may be respectively driven to rotate by mutually independent traveling motors.

As a preference, the frame may be provided with two driven wheels, and an axle may be provided between the driven wheels to ensure that the four wheels may be supported on the ground and avoid the movement of goods on the shelf.

As a preference, the stand and the shelf may be provided are oppositely provided on horizontal sides of the column, and the column may be inclined from bottom to top to the side away from the stand, which facilitates the operators with arger bodies, especially those with fatter upper bodies.

As a preference, the column may be provided with a vertical groove, the vertical groove may be provided with a plurality of slots. The shelf may include a base that can move up and down along the vertical groove, the base may be hinged with a cargo plate, a connecting rod may be hinged on the cargo plate. The end of the connecting rod may be hinged with a limit rod, and one end of the limit rod may be inserted into the slot, so that the height of the shelf can be adjusted in the height direction.

As a preference, the stand may include a guardrail, an openable door may be provided on the side of the guardrail opposite to the column, and a console may be provided on the side of the column, which may be convenient for picking up goods and controlling the platform to lifting.

As a preference, a cavity may be provided on the frame on the lower side of the shelf, and a battery may be provided in the cavity.

In summary, compared with the prior art, the present disclosure has the following advantages: pure electric is adopted for driving and lifting, it is safety and friendly to environment, with low noise; it is more suitable for indoor goods picking operations, and can meet the needs of society for energy conservation and emission reduction, and avoid affecting the indoor environment, and maintenance is convenient; the structure is compact and the stability is high, which can effectively ensure the safety of the operators.

### BRIEF DESCRIPTION OF THE DRAWINGS

FIG. 1 is a schematic diagram of the structure of the present disclosure;

FIG. 2 is a front view of the internal structure of the present disclosure;

FIG. 3 is an enlarged view of the structure at part A in FIG. 2;

FIG. 4 is a side view of the internal structure of the present disclosure;

FIG. 5 is a schematic view of the structure of the present disclosure from another perspective;

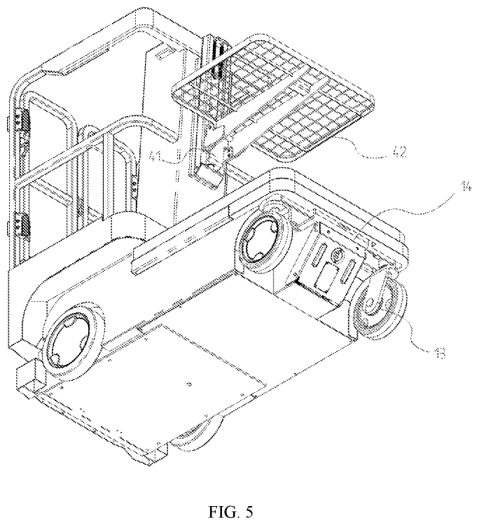

FIG. 6 is a schematic diagram of the motor structure.

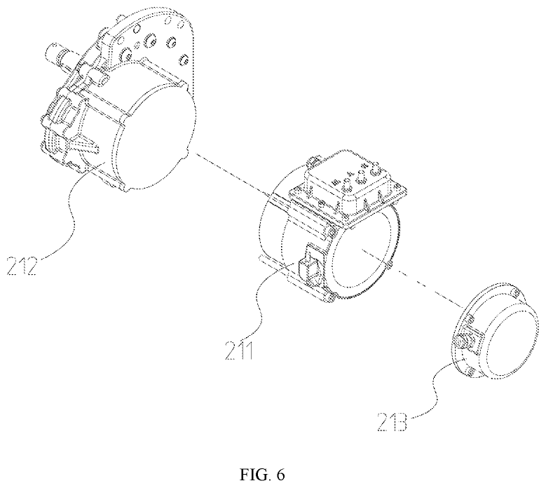

The numerals in the figures are listed as follows: 1—frame, 11—bottom plate, 12—driving wheel, 13—driven wheel, 14—axle, 15—cavity, 16—battery, 17—cover plate, 2—column, 21—electric push rod, 211—motor, 212—reducer, 213—brake, 214—push rod, 22—multi-stage sleeve, 221—outer sleeve, 222—inner sleeve, 223—middle sleeve, 224—connecting cylinder, 2241—vertical groove, 2242—slot, 225—roller, 226—chain, 3—stand, 31—guardrail, 32—door, 33—console, 4—shelf, 41—base, 42—cargo plate, 43—connecting rod, 44—limit rod, 51—detection chain, 52—fixing seat, 53—connecting rod, 54—spring, 55—anti-loosening rod, 56—micro switch, 57—steering member, 58—chain wheel.

### DETAILED DESCRIPTION OF THE EMBODIMENTS

The present disclosure will be further described below with reference to the embodiments in the drawings.

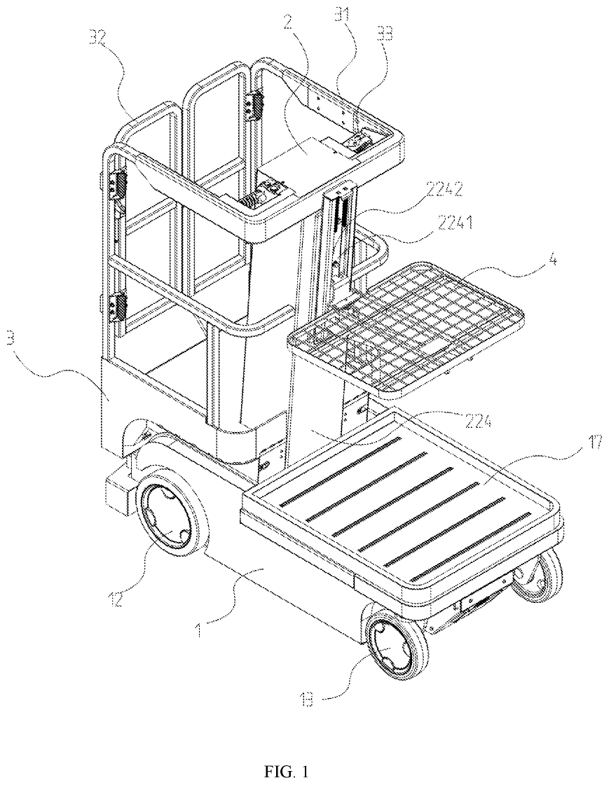

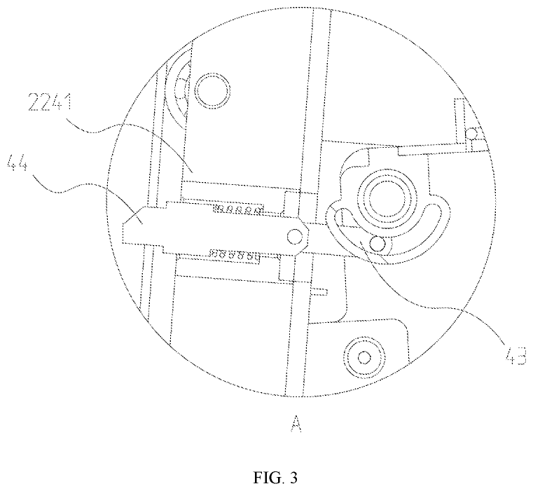

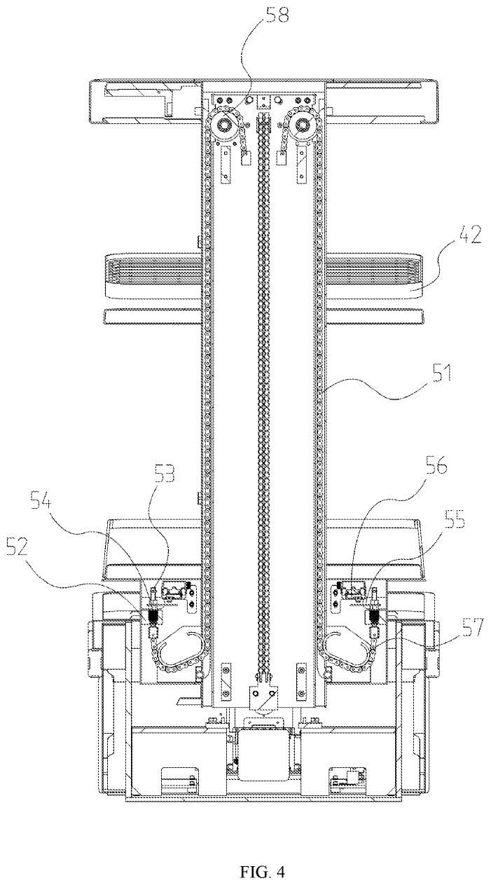

As shown in FIGS. 1 to 4, the electric lifting type cargo work platform may include a frame 1, a column 2, a stand 3, and a shelf 4. The column 2 may be provided on the frame 1. The column 2 may include an electric push rod 21 and a multi-stage sleeve 22. The multi-stage sleeve 22 may include a connecting cylinder 224, an outer sleeve 221, an inner sleeve 222 and the middle sleeve 223 that may be sleeved from outside to inside in sequence. The middle sleeve 223 may be provided with rollers 225, each of the roller 225 may be provided with a chain 226. One end of the chain 226 may extend downward and may be connected with the outer sleeve 221, the other end may be connected with the frame 1. The output end of the electric push rod 21 may be connected to the middle sleeve 223. The electric push rod 21 and the inner sleeve 222 may be both fixed on the frame 1. The electric push rod 21 may push the middle sleeve 223 to move upward, and the middle sleeve 223 drives the outer sleeve 221 to move via the structure including the roller 225 and chain 226 while moving up, such that synchronous extending and retracting can be achieved. The stand 3 and the shelf 4 may be provided on the column 2 and can move in the height direction by means of the column 2.

The electric push rod 21 may include a motor 211, a brake 213, a reducer 212, a screw and a push rod 214. The reducer 212 and the brake 213 may be provided on both sides of the motor 211. The output end of the reducer 212 may be connected to the screw and can drive the screw to rotate, and the screw may drive the push rod to move. The motor 211 may be located at the lower end of the inner sleeve 222. The brake 213, the motor 211 and the reducer 212 may be provided in the horizontal direction from the outside to the inside. The output end of the reducer 212 may be bent upward, and the screw may be parallel to the column 2. In one embodiment, the brake 213 may be provided with brake pads that move along the shaft of the motor 211, and an arrester may be rotatably connected to the motor shaft. The brake pad can be driven by electromagnetic and spring to move relative to the arrester to achieve both contact and separation, and then brake. The use of an integrated brake structure reduces the size of the motor, which may be convenient to be arranged in the frame 1, such that it is convenient for installation and maintenance, and can avoid problems such as difficulty in maintenance of the hydraulic drive structure and easy oil leakage.

The front and rear ends of the upper part of the middle sleeve 223 may be provided with rollers 225, the chain 226 bypasses the two rollers 225, and one end thereof may be located on the side of the shelf 4 and may extend downward to the lower end of the outer sleeve 221. When the middle sleeve is moving upward, the chain 226 at this end may drive the outer sleeve 221 to move upward, and the other end of the chain 226 may be located on the side of the stand 3 and may extend downward to connect with the bottom plate 11 of the frame 1. One end of the chain 226 may extend downward to the lower end of the inner sleeve 222, and may be fixed on the bottom plate 11 after bypassing the horizontal shaft. Two sets of rollers and chain drive structures may be provided along the horizontal direction, to ensure the lifting capacity and stability, and prevent a torque from being generated.

The connecting cylinder 224 may be provided outside the outer sleeve 221 and can move up and down relative to the outer sleeve 221, and the stand 3 and the shelf 4 may be provided on the connecting cylinder 224. The outer sleeve 221 may be provided with detection chains 51, and the connecting cylinder 224 may be provided with a fixing seat 52. One end of each of the detection chain 51 may be fixed to the upper end of the outer sleeve 221, and the other end may be provided with a connecting rod 53 that passes through the fixing seat 52. A spring 54 may be provided between the fixing seat 52 and the connecting rod 53. An anti-loosening rod 55 may be provided on the connecting rod 53. The anti-loosening rod 55 may be provided horizontally, and a micro switch 56 may be provided on the upper side of the anti-loosening rod 55. The connecting rod 53 may be a screw rod, on which two nuts may be provided, and the two nuts clamp the anti-loosening rod 55. The spring 54 may be sandwiched between the nut and the fixing seat 52. In a normal state, the detection chain 51 may be tightened and the spring 54 may be compressed. When the detection chain 51 is loosen or broken, a relative movement between the connecting cylinder 224 and the outer sleeve 221 may be detected at this time. The spring 54 may push the anti-loosening rod 55 and may contact the micro switch 56. The signal generated by the micro switch 56 can be read by the controller. A chain wheel 58 may be provided on the outer sleeve 221, and the detection chain 51 may pass around the chain wheel 58 from the upper side, and extend downward to the lower end of the connecting cylinder 224, and then may pass from the lower side to the steering member 57 on the vertical plate on the side of the connecting cylinder 224. The steering member 57 may be C-shaped, that is, the detection chain 51 bypasses the chain wheel and the steering member may be S-shaped as a whole. Two detection chains 51 may be symmetrically provided on the horizontal side of the outer sleeve 221, so that the tilt of the connecting cylinder 224 and the outer sleeve 221 can be detected at the same time.

The vehicle frame 1 may be provided with two driving wheels 12, the driving wheels 12 may be located below the stand 3, and the driving wheels 12 may be respectively driven to rotate by mutually independent traveling motors. The output shaft of each of the traveling motor 211 may be rotatably connected with the rotating shaft of the driving wheel 12. The two traveling motors may be respectively located on the driving wheel 12 on the side close to the middle of the frame 1. The traveling motor 211 may be connected with the controller to realize platform steering through differential control.

The frame 1 may be provided with two driven wheels 13, the driven wheels 13 may be located below the shelf 4. An axle 14 may be provided between the driven wheels 13. When encountering uneven roads, four wheels can be ensured to support the ground, and the movement of the goods on the shelf 4 can be avoided.

The stand 3 and the shelf 4 may be provided on the horizontal sides of the column 2 oppositely. The column 2 may be inclined from bottom to top to the side away from the stand 3, which may be convenient for use by operators with larger bodies, especially those with fat upper bodies. The situation that operator's body can cause interference when leaning forward may be avoided, and the operator's center of gravity on the stand 3 moves to the side of the shelf 4 to improve the stability of the platform.

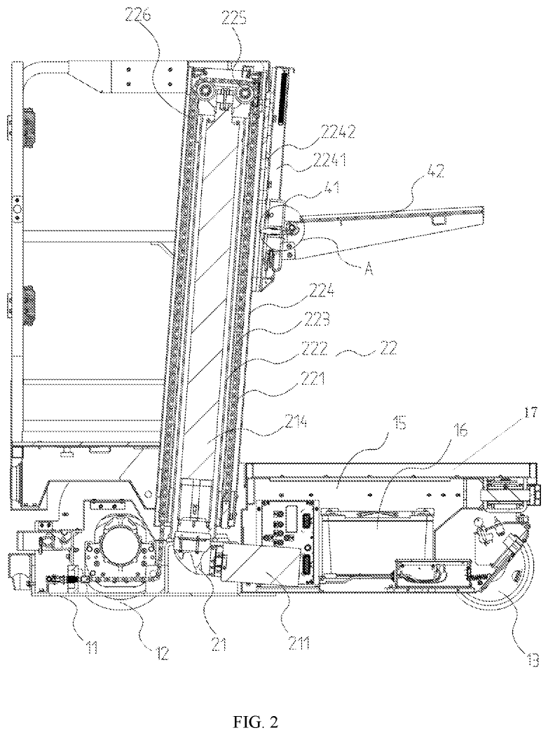

As shown in FIG. 2, the column 2 may be provided with a vertical groove 2241, and a plurality of slots 2242 may be provided vertically in the vertical groove 2241. The shelf 4 may include a base 41 that can move up and down along the vertical groove 2241. A cargo plate 42 may be hingedly connected with the base 41. The connecting rod 43 may be hinged on the cargo plate 42. The end of the connecting rod 43 may be hinged with a limit rod 44, and one end of the limit rod 44 may be inserted into the slot 2242. The cargo plate 42, the connecting rod 43 and the limit rod 44 may form a linkage mechanism. The cargo plate 42 may press down to drive the limit rod 44 to squeeze under the inner side of slot 2242. The cargo plate 42 can ensure the connection structure under its own weight. The stability of the connection structure can be further ensured when the goods is placed. The base 41 may be a sheet metal structure, on which two rollers rolling along the bottom surface of the vertical groove 2241 may be provided, and the limit rod 44 may pass through the base 41. The limit rod 44 can be drawn out when upturning the cargo plate 42, and the limit rod 44 can be moved and inserted into the slot 2242 at the corresponding height to achieve height adjustment. Two springs may be provided between the upper end of the base 41 and the inner top surface of the vertical groove 2241, which cooperate with the above linkage mechanism to ensure the safety of the structure.

The stand 3 may include a guardrail 31. The guardrail 31 may be provided with an openable door 32 at the side opposite to the column 2. The door 32 may be connected to the guardrail 31 by a loose leaf. The side of the column 2 may be provided with a handle and a manual console 33. The frame 1 may be provided with a cavity 15 on the lower side of the shelf 4. The cavity 15 may be provided with a battery 16, and the upper side of the cavity 15 may be provided with a cover plate 17, which can lower the center of gravity, and combine with the motor and the sleeve release structure to move the center of gravity to the middle side of the platform.

The above description is only an explanation of the present disclosure, so that a person of ordinary skill in the art can implement the solution completely, but it is not a limitation of the present disclosure. After reading this specification, those skilled in the art can make modifications that have no inventive contribution in this embodiment as needed. The modifications without any inventive effort are protected by the patent law as long as they fall within the scope of the claims of the present disclosure.

1. An electric lifting type cargo work platform, wherein comprising:
a frame, a column, a stand and a shelf; the column being provided on the frame; the column comprising an electric push rod and a multi-stage sleeve, and the multi-stage sleeve comprising a connecting cylinder, an outer sleeve, an inner sleeve and a middle sleeve; the middle sleeve being provided with rollers, each of the rollers being provided with a chain; one end of the chain extending downward and being connected to the outer sleeve, an other end being connected to the frame, and an output end of the electric push rod being connected to the middle sleeve; the stand and the shelf being provided on the column and capable to move in a height direction by means of the column.

2. The electric lifting type cargo work platform according to claim 1, wherein: the electric push rod comprises a motor, a brake, a reducer, a screw and a push rod; the reducer and the brake are provided on both sides of the motor, and an output end of the reducer is connected to the screw and drives the screw to rotate, the screw drives the push rod to move.

3. The electric lifting type cargo work platform according to claim 1, wherein: the middle sleeve is provided with the rollers at an front end and at an rear end, respectively; the chain bypasses two of the rollers, of which the one end is located at one side of the shelf and may extend downward to a lower end of the outer sleeve, and the other end is located at one side of the stand and may extend downward to connect with a bottom plate of the frame.

4. The electric lifting type cargo work platform according to claim 1, wherein: the stand and the shelf are provided on the connecting cylinder; the outer sleeve is provided with a detection chain, the connecting cylinder is provided with a fixing seat; one end of the detection chain is provided with a connecting rod, the connection rod passes through the fixing seat and is provided with a spring between the fixing seat and the connection rod; the connecting rod is provided with an anti-loosening rod, one side of the anti-loosening rod is provided with a micro switch.

5. The electric lifting type cargo work platform according to claim 1, wherein: the frame is provided with two driving wheels, and the driving wheels are rotated by driving of traveling motors that are independent to each other, respectively.

6. The electric lifting type cargo work platform according to claim 1, wherein: the frame is provided with two driven wheels, an axle is provided between the driven wheels.

7. The electric lifting type cargo work platform according to claim 1, wherein: the stand and the shelf are oppositely provided on horizontal sides of the column, the column is inclined from bottom to top to one side away from the stand.

8. The electric lifting type cargo work platform according to claim 1, wherein: the column is provided with a vertical groove, and the vertical groove is provided with a plurality of slots; the shelf comprises a base that can move up and down along the vertical groove, the base is hinged with a cargo plate, the cargo plate is hinged to a connecting rod, the connecting rod is hinged to a limit rod at one end, and one end of the limit rod is inserted into the slot.

9. The electric lifting type cargo work platform according to claim 1, wherein: the stand comprises a guardrail, and the guardrail is provided with an openable door at one side opposite to the column, and the column is provided with a console at one side.

10. The electric lifting type cargo work platform according to claim 1, wherein: the frame is provided with a cavity at a lower side of the shelf, and the cavity is provided with a battery.
